(19) United States
(12) Patent Application Publication
(10) Pub. No.: US 2009/0101703 A1
(43) Pub. Date: Apr. 23, 2009

(54) Director Voting Method

(76) Inventors: Alastair Mark Percival, Christchurch (NZ); Alessandro Sodi, Manhasset, NY (US); Robert Howard Craig, Asheboro, NC (US); Nicolas Jon Smith, Christchurch (NZ); Bert Matthijs Van Brakel, Christchurch (NZ); Christopher Roderick McLeod, Christchurch (NZ)

Correspondence Address: JOHN ALEXANDER GALBREATH, 2516 CHESTNUT WOODS CT, REISTERSTOWN, MD, 21136, US

(21) Appl. No.: 12/016,351

(22) Filed: Jan. 18, 2008

(30) Foreign Application Priority Data
Oct. 23, 2007 (NZ) 562751

(51) Int. Cl. G07C 13/00

(52) U.S. Cl. 235/51

(57) ABSTRACT

The invention relates to a method for a board of directors to vote on a board document that includes the following steps in order:
A. an administrator uploads a board document for consideration onto a processing centre and configures an associated voting module;
B. the administrator creates, or reuses an existing, director voting account associated with each director and uploads this to the processing centre; said voting account includes an authenticated graphical indicia for that director;
C. the administrator configures the processing centre to allow access to the board document and associated voting module;
D. the administrator supplies each director with login details for their voting account;
E. each director logs in to their voting account and reviews the board document;
H. each director logs into their voting account and casts a non rescindable vote relating to the board document, and appends their graphical indicia to that vote.

### FIELD OF THE INVENTION

The present invention is a method of allowing a director to vote on a board paper online.

### BACKGROUND

Directors on the boards of companies are required to consider and vote on various proposals; these proposals are normally presented in the form of documents called board papers. These papers are traditionally printed, collated and sent out to the directors some time before a meeting is convened to vote on the various board papers.

The confidentiality of the board documents and the effect they can have on customers and the public's perception of the company concerned means they have to be carefully protected. The distribution of the board documents requires care so that this confidentiality is maintained. With many directors now members of more than one board and travel being both easier and cheaper getting board documents to a director can be difficult and/or expensive. For example how can a courier be certain that the person accepting delivery is the director it is intended for?

Problems that can occur with physical delivery methods include the loss, damage or delay of the board documents, through accident or theft for example. This means that those who send out the documents need to have reliable feedback systems to ensure they know the documents are received. These feedback systems can be onerous and/or expensive, a signature indicating delivery of the documents needs to be checked for, and if sensitive documents are involved, the authenticity by comparison with a sample may be required.

Once a director receives the board documents they need to consider them, and in many cases ask questions to clarify some of the issues. The questions themselves may include sensitive information and/or require confidential information is provided this transfer of information needs to be carefully managed. If the board documents relate to a proposal that requires a quick decision is made it may not be possible for the director to receive a response to the question, in this case a less than optimal decision may be made.

Once a director has considered a board paper they may wish to ask questions of the proposer to clarify a point or question the data or conclusion. If they do then it may take some time to receive a response, which can delay the decision on the proposal. Some proposals are time critical and any delay in making a decision may in fact make affect the viability of the proposal.

Traditionally the board of directors for an organisation meets physically to consider each board document, these meetings may occur on a regular or irregular basis. To get all of the directors to a meeting can be expensive due to travel, accommodation and meeting room costs. In some cases the board documents for consideration require nothing more than a simple vote and signing off by each director, this can make the costs disproportionate to the meeting. This signing off may require the directors sign a document indicating they have seen and considered the document, the signature acting as proof that they have seen the board document.

In addition to the organizational considerations some directors may be travelling significant distances to attend board meetings without any cool down period before the meeting, this may affect their decisions.

It is therefore an object of this invention to provide a method by which a director can vote on a board document which overcomes one or more of the deficiencies described above and/or provides a useful economic choice over present methods.

The present invention provides a method for a board of directors to vote on a board document that includes the following steps in order:
A. an administrator uploads a board document for consideration onto a processing centre and configures an associated voting module;
B. the administrator creates, or reuses an existing, director voting account associated with each director and uploads this to the processing centre, said voting account includes an authenticated graphical indicia for that director
C. the administrator configures the processing centre to allow access to the board document and associated voting module;
D. the administrator supplies each director with login details for their voting account;
E. each director logs in to their voting account and reviews the board document;
H. each director logs into the voting account and casts a non rescindable vote relating to the board document, and appends their graphical indicia to that vote.

Preferably if a director has a question relating to the board document the question is forwarded to the administrator and the following steps in order are inserted after step E and before step H:
F. the administrator forwards the question to the board document proposer and, once received, uploads an answer to the question to the processing centre for access by each director;
G. each director logs into the voting account and reviews the answer, if any director has a further question then this is transmitted to the administrator and step F is actioned, otherwise step H is actioned;

Preferably the voting module is configured to carry out one or more operations selected from the list consisting of: update how each director has voted once their vote has been cast, update the vote tally, confirm the vote status of the board document, display the votes cast, provide access to the questions asked and provide access to the answers to the questions.

The invention also includes a computer based system incorporating the method, said system includes an administrator account configured to be accessed by an administrator, a processing centre, a voting module and a separate voting account associated with each of a number of directors authorised to vote; such that the processing centre stores and provides access to the voting module, each voting account and the board document; each said voting account includes an electronically stored graphical indicia relating to the associated director and is configured to append this indicia to the associated director's vote once cast, each director can access only the voting account associated with them.

Preferably the or each director's vote once cast is not rescindable.

Preferably the graphical indicia stored by each voting account is the signature of the associated director, though it could be a fingerprint, photograph or other graphical indicia.

Preferably the administrator account is configured to allow the administrator to amend the board document only when no votes have been cast. Preferably if amendments to the board document are made, each voting account that has accessed the board document prior to those amendments is notified.

Preferably the voting module is configured to provide one or more of the following: —details of the votes already cast, a visual indication of the status of the vote, list of the directors who have voted and a combination of the above.

By way of example only a preferred embodiment of the present invention will be described in detail with reference to the accompanying drawings in which:

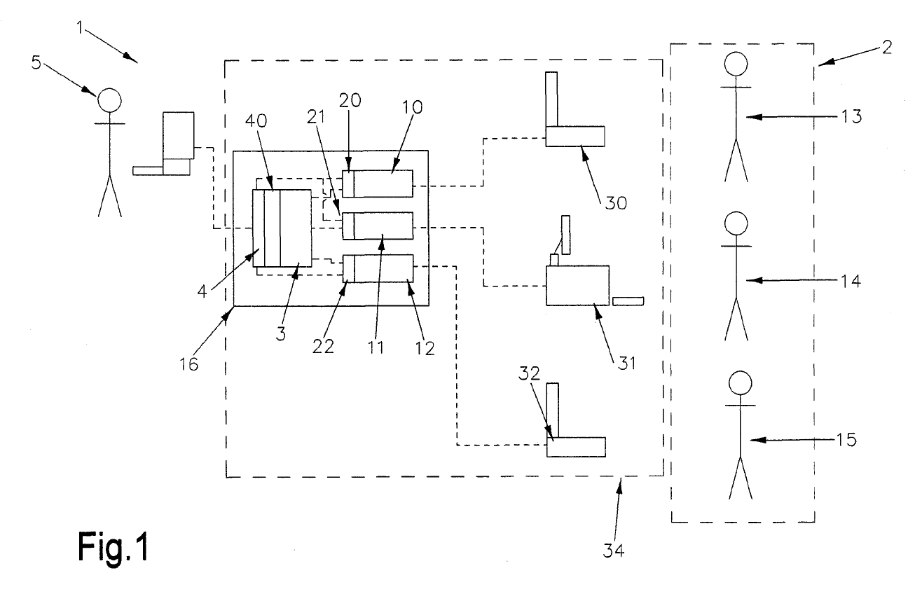

FIG. 1 is a schematic view of a system incorporating the director voting method;

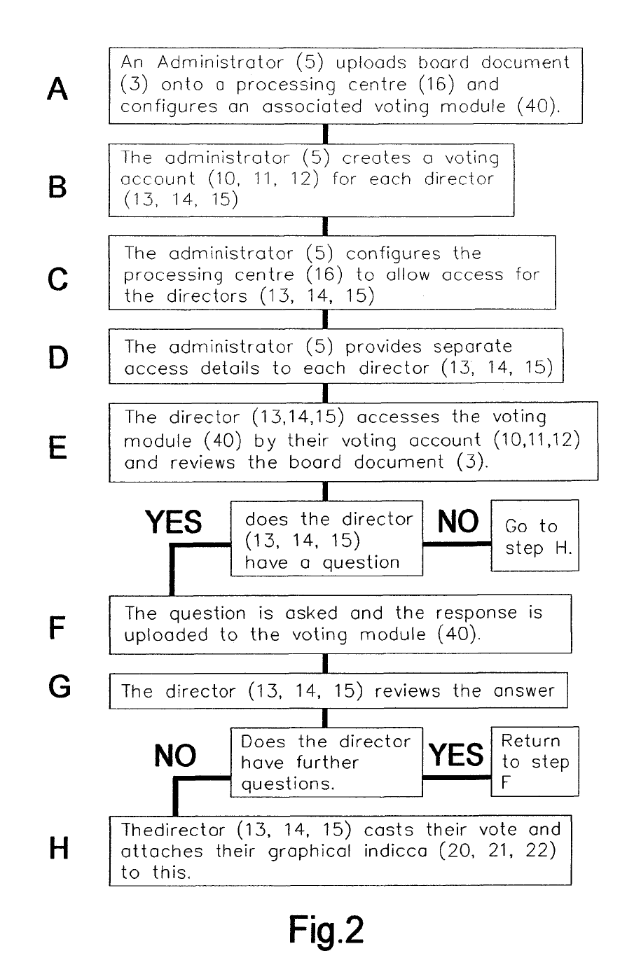

FIG. 2 is a flowchart of the director voting method.

Referring to FIG. 1 a computer based director voting system (1) incorporating a method for a board of directors (2) to vote on a board document (3) is shown. The system (1) includes an administrator account (4) accessible by an administrator (5), a director voting account (10,11,12) for each director (13,14,15) entitled to vote and a processing centre (16). The processing unit (16) is configured to store each director voting account (10,11,12) and an electronic copy of the board document (3) to be voted on.

The board document (3) may include video presentations and other material not traditionally associated with paper board documents.

Each voting account (10,11,12) includes an electronically stored indicia (20,21,22) for that director (13,14,15), this indicia (20,21,22) may be a scanned signature, scanned fingerprint or other similar identifier. In many cases the directors (13,14,15) are expected to sign off on the proposal contained in the board document (3), thus applying an electronic signature meets a legal/constitutional obligation.

The processing centre (16) is configured to be connected a director's computer (30,31,32) for each director (13,14,15) either directly or via a network (34). The network (34) may include the Internet, a wide and/or local area network or combination of these.

In short, the system (1) is configured to allow an authorised director (13,14,15) to electronically, remotely, access a board document (3) to be voted on and cast their vote by applying an authenticated graphical indicia (20,21,22) to it. Once cast the vote is irrevocable.

The administrator (5) using the administrator account (4) can edit the board document (3) only prior to any votes being cast, and if an amendment is made each voting account (10,11,12) is updated to reflect this.

A preferred method of implementing the method is shown in FIG. 2, said method includes the following steps in order:

In step A, the administrator (5) uploads a board document (3) to the processing centre (16), using the administrator account (4), and associates this with a provided list of directors (13,14,15) permitted to vote on the board document (3). In addition the administrator (5) sets up a voting module (40) associated with the board paper (3). The voting module (40) is configured with the criteria for acceptance or rejection of the board document (3): —this includes the number of votes required, whether a certain number of these votes need to be independent director's votes and whether the votes of other directors should be visible. For example for one board document (3) you may only be able to view the votes cast once you have voted or you may only be able to see the number of votes required to pass the board document (3).

In step B, the administrator (5) creates new director voting accounts (10,11,12), or links to already loaded director voting accounts (10,11,12) associated with each director (13,14,15) on the list. If the voting account (10,11,12) is a new account the administrator (5) uploads and stores a graphical indicia (20,21,22) associated with the director (13,14,15) into this voting account (10,11,12). The graphical indicia (20,21,22) is unique to the director (13,14,15) concerned and is most likely to be a scanned signature or fingerprint able to be represented on a computer monitor.

In step C the administrator (5) configures the processing centre (16) to allow the voting accounts (10,11,12) access to the board document (3) and voting module (40) for that board document (3). This may be manually or automatically set up, for example the board document (3) may be scheduled to be accessed at a specific time in the future, or be accessible for a very limited time.

In step D the administrator (5) provides voting account (10,11,12) login details including passwords or physical access keys to each director (13,14,15) for the board document (3) under consideration.

In step E each director (13,14,15), at a time convenient to themselves, logs onto their voting account (10,11,12) using the provided login details provided. Once logged in the director (13,14,15) has access to the board document (3) and the voting module (40) for it. The director (10,11,12) may have some questions to ask regarding the board document (3), if they do then they go to step F. If no questions need to be asked then go to step H.

Step F the administrator (5) seeks an answer from the proposer, and the answer if forthcoming is provided to the or all of the directors (13,14,15). Step G is then actioned.

Step G the director (13,14,15) logs into their voting account (10,11,12) and reviews the answer, if they have no further questions then they proceed to step H. If the director (13,14,15) has a further question then they transmit this question to the administrator (5) and step F is repeated until all the questions are answered or responded to.

In step H the director (13,14,15) then accesses the voting module (40) and casts their vote for the board paper (3). To confirm that this is their vote they apply their electronic graphical indicia (20,21,22) to it. Once this is done the vote cannot be rescinded without deleting the board paper (3).

Optionally step I can be actioned, where in step I the voting module (16) is configured to tally the votes cast and graphically display this information. This allows the directors (13,14,15) to track the progress of a board document (3), it may also allow the director (13,14,15) to see who has cast their votes and which way they voted.

Once all of the votes required to pass or reject a board document (3) are cast the voting module (40) is configured to make the result available to the directors (13,14,15) in their voting account (10,11,12). Alternatively the voting module (40) can be configured to display the votes cast prior to a director (13,14,15) casting their vote. The information displayed can include details of which directors have voted (13,14,15) and what their vote was and the state of the vote in real time.

With the board document (3) electronically stored in a centralized location, the processing centre (16), various controls can be applied to it. For example the board document (3) may not be able to be printed or downloaded from the processing centre (16) thus preventing it easily becoming public. The board document (3) may require the computer (30,31,32) accessing it includes certain hardwired components, thus preventing access even if one directors (13,14,15) login data is lost/stolen.

It is possible to construct the board document (3) so that sensitive parts of the board document (3) are locked out if it is not accessed on the processing centre (16) by an authenticated director (13,14,15) on an authenticated machine (30,31,32). In addition the board document (3) may be loaded in such a way as to prevent the administrator (5) viewing the board document (3).

Once voting has commenced the board document (3) is unable to be edited, though prior to this certain amendments may be allowed.

In a preferred embodiment the network connection between the directors computers (30,31,32) and the processing centre (16) is encrypted. This encryption can be any of the known methods for encrypting data on a computer network.

In short the administrator (5) loads the board document (3) and director voting accounts (10,11,12) electronically onto the processing centre (16), and configures the voting module (40) with the required voting criteria. Each director (13,14,15) then logs into their voting account (10,11,12) to accesses the processing centre (16), to review the board document (3) and vote on that board document (3). Each director (13,14,15) can log onto the processing centre (16) at any convenient time to review the board document (3), ask questions, review answers or cast their vote on a board document (3); traditional board meetings do not allow this freedom. Each vote, once cast, is final and only by deleting the entire board document (3) can the vote be rescinded. Their vote once made, requires the director (13,14,15) applies a graphical indicia (20,21,22), normally an electronic copy of their signature, to their vote, and in many cases the board document (3).

Any discussion of the prior art throughout the specification is not an admission that such prior art is widely known or forms part of the common general knowledge in the field.

1. A method for a board of directors to vote on a board document that includes the following steps in order:
A. an administrator uploads a board document for consideration onto a processing centre and configures an associated voting module;
B. the administrator creates, or reuses an existing, director voting account associated with each director and uploads this to the processing centre; said voting account includes an authenticated graphical indicia for that director;
C. the administrator configures the processing centre to allow access to the board document and associated voting module;
D. the administrator supplies each director with login details for their voting account;
E. each director logs in to their voting account and reviews the board document;
H. each director logs into their voting account and casts a non rescindable vote relating to the board document, and appends their graphical indicia to that vote.

2. The method for a board of directors to vote on a board document as claimed in claim 1 characterised in that if a director has a question relating to the board document, the question is forwarded to the administrator and the following steps in order are inserted after step E and before step H:
F. the administrator forwards the question to the board document proposer and, once received, uploads an answer to the question to the processing centre for access by each director;
G. each director logs into the voting account and reviews the answer, if any director has a further question then this is transmitted to the administrator and step F is actioned, otherwise step H is actioned.

3. The method for a board of directors to vote on a board document as claimed in claim 1 characterised in that the voting module is configured to carry out one or more operations selected from the list consisting of: update how each director has voted once their vote has been cast; update the vote tally; confirm the vote status of the board document; display the votes cast; provide access to the questions asked and provide access to the answers to the questions.

4. A computer based system incorporating a method for a board of directors to vote on a board document, said system including an administrator account configured to be accessed by an administrator, a processing centre, a voting module and a separate voting account associated with each of a number of directors authorised to vote; such that the processing centre stores and provides access to the voting module, each voting account and the board document; each said voting account includes an electronically stored graphical indicia relating to the associated director and is configured to append this indicia to the associated director's vote once cast; and each director can access only the voting account associated with them.

5. The computer based system as claimed in claim 4 characterised in that the or each director's vote once cast is not rescindable.

6. The computer based system as claimed in claim 4 characterised in that the graphical indicia stored by each voting account is selected from the group consisting of: the signature of the associated director; a fingerprint of the associated director; a photograph and a unique symbol.

7. The method as claimed in claim 1 characterised in that the authenticated graphical indicia is selected from the group consisting of: the signature of the associated director; a fingerprint of the associated director; a photograph and a unique symbol.

8. The computer based system as claimed in claim 4 characterised in that the administrator account is configured to allow the administrator to amend the board document only when no votes have been cast.

9. The computer based system as claimed in claim 4 characterised in that if amendments to the board document are made, each voting account that has accessed the board document prior to those amendments is notified.

10. The computer based system as claimed in claim 4 characterised in that the voting module is configured to provide one or more of the following: —details of the votes already cast; a visual indication of the status of the vote; a list of the directors who have voted and a combination of the above.
